(19) United States
(12) Patent Application Publication
(10) Pub. No.: US 2026/0079472 A1
(43) Pub. Date: Mar. 19, 2026

(54) INFORMATION PROCESSING APPARATUS, AND METHOD AND PROGRAM FOR GENERATING NC PROGRAM

(71) Applicant: DMG MORI CO., LTD., Nara (JP)

(72) Inventor: Michihiko ITO, Sapporo HOKKAIDO (JP)

(73) Assignee: DMG MORI CO., LTD., Nara (JP)

(21) Appl. No.: 18/870,409

(22) PCT Filed: Nov. 1, 2024
(86) PCT No.: PCT/JP2024/039060

§ 371 Date: Nov. 28, 2024

(30) Foreign Application Priority Data
Dec. 13, 2023 (JP) 2023-209792
Apr. 15, 2024 (JP) 2024-065534

(51) Int. Cl. G05B 19/4155; G05B 19/409; G05B 19/4093

(52) U.S. Cl. CPC G05B 19/4155; G05B 19/409; G05B 19/40938; G05B 2219/32128

(57) ABSTRACT

An information processing apparatus (100) includes: a user interface processing unit (131) that receives a selection of a controller for a machine tool; a storage unit (136) that stores a correspondence relationship between CL data, controllers and NC codes; and a program generation unit (112) that generates an NC program from the CL data based on (a) a selected controller (155) received by the user interface processing unit (131) and (b) a correspondence relationship between the selected controller (155), (b-1) the CL data and (b-2) the NC codes.

### TECHNICAL FIELD

The present invention relates to an information processing apparatus, and a method and a program for generating an NC program.

### BACKGROUND ART

For example, Japanese Patent No. 7,301,486 (PTL 1) discloses an information processing apparatus including a first conversion unit that converts a second NC program into CL data, an interpretation unit that interprets the CL data, a reception unit that receives an input of an execution code to be executed by a machine tool, and a second conversion unit that converts the CL data into a first NC program that includes the execution code received by the reception unit based on the interpretation of the CL data.

### CITATION LIST

### Patent Literature

PTL 1: PTL 1: Japanese Patent No. 7,301,486

### SUMMARY OF INVENTION

### Technical Problem

As disclosed in PTL 1, there is known an information processing apparatus that generates, from CL data, an NC program for use in a machine tool. In such an information processing apparatus, since an NC code to be replaced from the CL data differs depending on the type of a controller (manufacturer), it is required to generate an NC program suitable for a controller provided in the machine tool.

An object of the present invention is to provide an information processing apparatus, and a method and a program capable of generating an NC program suitable for a controller of a machine tool.

### SOLUTION TO PROBLEM

An information processing apparatus according to one aspect of the present invention is an information processing apparatus that generates an NC program for use in a machine tool. The information processing apparatus includes: a user interface processing unit that receives a selection of a controller for the machine tool; a storage unit that stores a correspondence relationship between CL data, controllers and NC codes; and a program generation unit that generates an NC program from the CL data based on (a) a selected controller received by the user interface processing unit and (b) a correspondence relationship between the selected controller, (b-1) the CL data and (b-2) the NC codes.

An information processing apparatus according to another aspect of the present invention is an information processing apparatus that generates an NC program for use in a machine tool. The information processing apparatus includes: a user interface processing unit that receives a selection of the machine tool; a storage unit that stores a correspondence relationship between CL data, machine tools and NC codes; and a program generation unit that generates an NC program from the CL data based on (a) a selected machine tool received by the user interface processing unit and (b) a correspondence relationship between the selected machine tool, (b-1) the CL data and (b-2) the NC codes.

A method for generating an NC program according to one aspect of the present invention is a method for generating an NC program for use in a machine tool. The method for generating an NC program includes: a step of receiving a selection of a controller for the machine tool; and a step of generating an NC program from the CL data based on (a) a selected controller received in the step of receiving a selection of a controller for the machine tool and (b) a correspondence relationship between the selected controller, (b-1) the CL data and (b-2) the NC codes.

A method for generating an NC program according to another aspect of the present invention is a method for generating an NC program for use in a machine tool. The method for generating an NC program includes: a step of receiving a selection of the machine tool; and a step of generating an NC program from the CL data based on (a) a selected machine tool received in the step of receiving a selection of the machine tool and (b) a correspondence relationship between the selected machine tool, (b-1) the CL data and (b-2) the NC codes.

A program according to one aspect of the present invention is a program for generating an NC program for use in a machine tool. The program causes a computer to execute: a step of receiving a signal specifying a selection of a controller for the machine tool; and a step of generating an NC program from the CL data based on (a) a selected controller received in the step of receiving a signal specifying a selection of a controller for the machine tool and (b) a correspondence relationship between the selected controller, (b-1) the CL data and (b-2) the NC codes.

A program according to another aspect of the present invention is a program for generating an NC program for use in a machine tool. The program causes a computer to execute: a step of receiving a signal specifying a selection of the machine tool; and a step of generating an NC program from the CL data based on (a) a selected machine tool received in the step of receiving a signal specifying a selection of the machine tool and (b) a correspondence relationship between the selected machine tool, (b-1) the CL data and (b-2) the NC codes.

### Advantageous Effects of Invention

According to the present invention, it is possible to provide an information processing apparatus, and a method and a program capable of generating an NC program suitable for a controller of a machine tool.

### BRIEF DESCRIPTION OF DRAWINGS

FIG. 1 is a block diagram illustrating an information processing apparatus according to an embodiment of the present invention.

FIG. 2 is a front view illustrating an example of a machine tool.

FIG. 3 is a diagram illustrating a model selection screen.

FIG. 4 is a table illustrating a correspondence relationship between CL data and NC codes used in various control devices in a drilling cycle (spot drilling cycle).

FIG. 5 is a table illustrating a correspondence relationship between CL data and NC codes used in various control devices in a drilling cycle (deep hole drilling cycle).

FIG. 6 is a diagram illustrating a step of machining a workpiece in a simulation of an NC program.

FIG. 7 is a diagram illustrating a simulation screen of an NC program.

FIG. 8 is a diagram illustrating another simulation screen of the NC program.

FIG. 9 is a diagram illustrating a coordinate system selection screen.

FIG. 10 is a diagram illustrating a step of machining a workpiece in a re-simulation of the NC program.

FIG. 11 is a flowchart illustrating a process of generating an NC program in the information processing apparatus illustrated in FIG. 1.

FIG. 12 is a flowchart illustrating a process of generating an NC program in a modification of the information processing apparatus illustrated in FIG. 1.

### DESCRIPTION OF EMBODIMENTS

Embodiments of the present invention will be described with reference to the drawings. In the following drawings, the same or corresponding members are denoted by the same reference numerals.

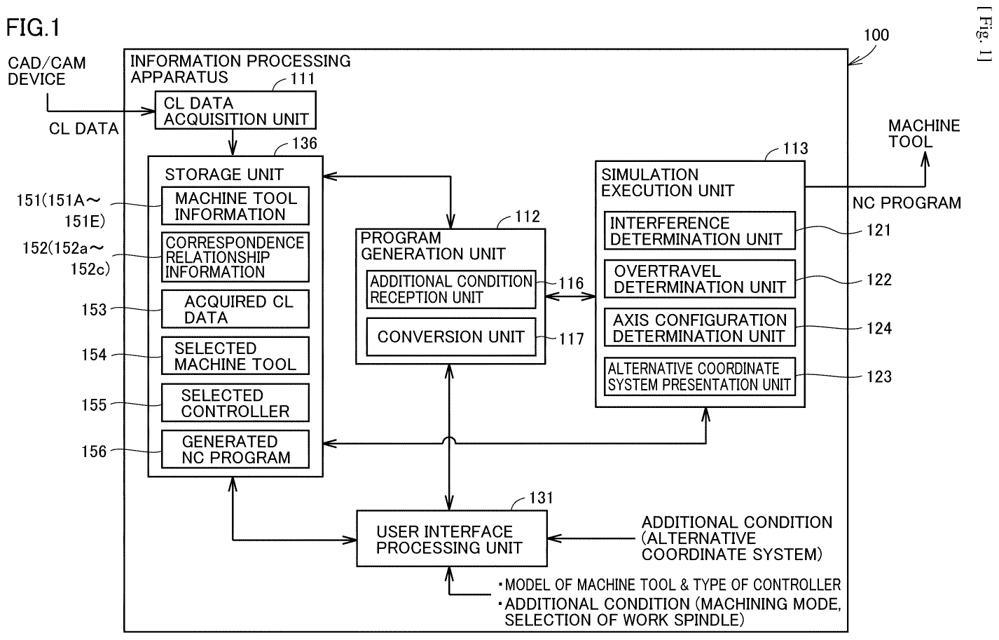

FIG. 1 is a block diagram illustrating an information processing apparatus according to an embodiment of the present invention. With reference to FIG. 1, an information processing apparatus 100 is configured to generate an NC (Numerical Control) program for use in a machine tool.

The information processing apparatus 100 receives CL (Cutter Location) data created by a CAD (Computer Aided Design) or CAM (Computer Aided Manufacturing) device, and generates an NC program from the CL data. The information processing apparatus 100 outputs the generated NC program to the machine tool.

The CL data includes information on cutting conditions such as tool position information (the three-dimensional position and orientation of the tool), spindle speed, and feed speed. The CL data may further include information on coolant discharge. In a step of machining a workpiece, the workpiece is machined by relatively moving the tool and the workpiece. The CL data further includes information about a coordinate system in which the tool and the workpiece are moved relatively in each machining step.

The CL data is described in, for example, APT (Automatically Programmed Tools). APT is a programming language developed for numerical control of machine tools and can automatically determine a tool path and machining steps based on the shape of a mechanical component to be produced. As a programming language that describes the CL data, an EXAPT (Extended Subset of APT) in which the tool path determination function of APT is more precisely improved may be used.

The NC program for use in a machine tool differs depending on the type of a controller (typically, the manufacturer of the controller) provided in the machine tool. The information processing apparatus 100 is configured to generate, from the CL data, an NC program for use in a machine tool provided with various controllers.

The machine tool that uses the NC program generated by the information processing apparatus 100 is not particularly limited. Examples of such a machine tool include an additive manufacturing machine that processes a workpiece by adding materials to the workpiece, a subtractive manufacturing machine that processes a workpiece by removing materials from the workpiece, and a laser processing machine that processes a workpiece by irradiating the workpiece with a light beam such as a laser. More specifically, a lathe, a drilling machine, a boring machine, a milling machine, a gear cutting machine, a grinding machine, a multi-spindle processing machine, a laser processing machine, a laminating machine, or the like is numerically controlled based on an NC program, and performs various kinds of machining such as turning, cutting, drilling, grinding, polishing, rolling, forging, bending, molding, micromachining, or laminating on a work piece such as metal, wood, stone, or resin. Further, some machine tools have a measuring function, and are configured to measure dimensions and the like of a workpiece using a measuring instrument such as a touch probe or a camera.

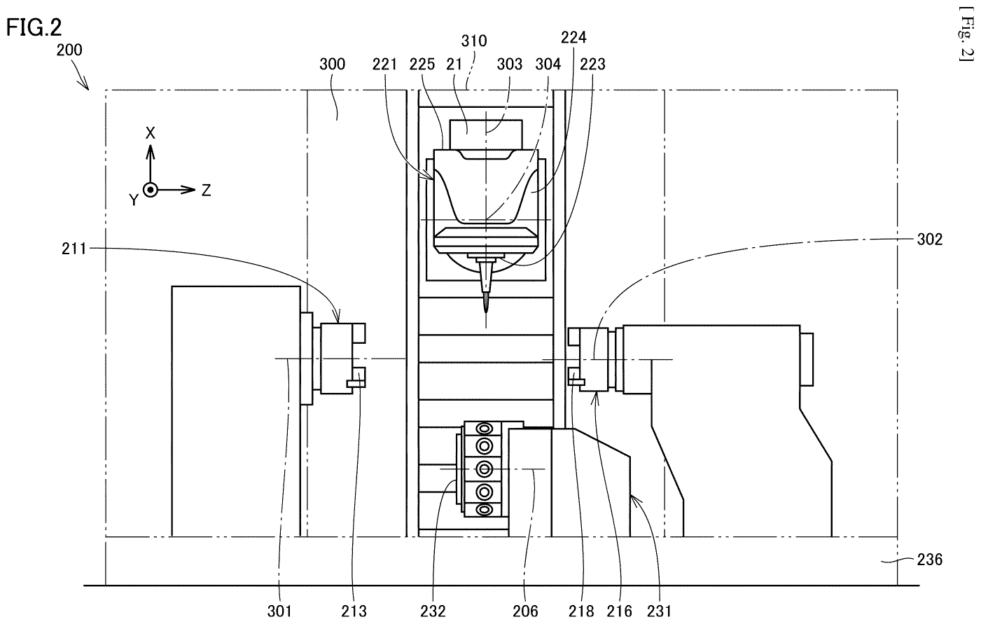

FIG. 2 is a front view illustrating an example of a machine tool. In FIG. 2, an internal structure of the machine tool is illustrated by seeing through a cover body (a splash guard) that forms an external appearance of the machine tool.

With reference to FIG. 2, a machine tool 200 is a composite machine that has a turning function which brings a tool into contact with a rotating workpiece to machine the workpiece and a milling function which brings a rotating tool into contact with a workpiece to machine the workpiece. The machine tool 200 is an NC (Numerically Controlled) machine tool which automatically performs various operations for machining a workpiece under numerical control of a computer, and operates in accordance with an NC program.

In the present specification, the axis parallel to the left-right direction (width direction) of the machine tool 200 and extending in the horizontal direction is referred to as the “Z axis”, the axis parallel to the front-back direction (depth direction) of the machine tool 200 and extending in the horizontal direction is referred to as the “Y axis”, and the axis extending in the upward-downward direction is referred to as the “X axis”. The right direction in FIG. 2 is referred to as the “+Z axis direction”, and the left direction is referred to as the “−Z axis direction”. In FIG. 2, the frontward direction of the paper is referred to as the “+Y axis direction”, and the backward direction is referred to as the “−Y axis direction”. The +Y axis direction corresponds to the front side of the machine tool, and the −Y axis direction corresponds to the back side of the machine tool. The upward direction is referred to as the “+X axis direction”, and the downward direction is referred to as the “−X axis direction”.

The machine tool 200 includes a bed 236, a work spindle 211, an opposing work spindle 216, a tool spindle (upper tool post) 221, and a tool post (lower tool post) 231.

The bed 236 is a base member configured to support the work spindle 211, the opposing work spindle 216, the tool spindle 221, the tool post 231 and the like, and is installed on a floor of a factory or the like. The bed 236 is made of metal such as cast iron.

The work spindle 211 and the opposing work spindle 216 are configured to hold a workpiece. The work spindle 211 and the opposing work spindle 216 are arranged to face each other in the Z axis direction. The work spindle 211 is configured to be rotated by a servo motor about a central axis 301 parallel to the Z axis. The opposing work spindle 216 is configured to be rotated by a servo motor about a central axis 302 parallel to the Z axis. The work spindle 211 is provided with a first chuck mechanism 213 for detachably gripping the workpiece, and the opposing work spindle 216 is provided with a second chuck mechanism 218 for detachably gripping the workpiece.

The work spindle 211 is fixed on the bed 236. The opposing work spindle 216 is configured to be moved in the Z axis direction by various kinds of feed mechanisms, guide mechanisms, servo motors, and the like.

The tool spindle 221 and the tool post 231 are configured to hold a tool. The tool spindle 221 is arranged above the tool post 231. The tool spindle 221 is configured to rotate about a central axis 303 parallel to the X axis in a reference posture to be described later. The tool spindle 221 is provided with a clamp mechanism (not shown) for detachably holding the tool.

The tool spindle 221 is further configured to turn about a central axis 304 parallel to the Y axis. The turning range of the tool spindle 221 is, for example, ±120° with reference to a reference posture (as illustrated in FIG. 2) in which a spindle end surface 223 of the tool spindle 221 faces downward.

The tool spindle 221 is supported on the bed 236 by a column or the like (not shown). The tool spindle 221 is configured to be moved in the X axis direction, the Y axis direction, and the Z axis direction by various kinds of feed mechanisms, guide mechanisms, servo motors, and the like provided in the column or the like.

The tool post 231 has a so-called turret shape, is radially attached with a plurality of tools, and is configured to perform turning dividing.

More specifically, the tool post 231 includes a turning portion 232. The turning portion 232 is configured to be turned about a central axis 206 parallel to the Z axis.

A tool holder for holding a tool is disposed at a position spaced apart from the central axis 206 in the circumferential direction. When the turning portion 232 is turned about the central axis 206, the tool held by the tool holder is moved in the circumferential direction, and thereby the tool used for machining is determined.

The tool post 231 is supported on the bed 236 by a saddle or the like (not shown). The tool post 231 is configured to be moved in the Z axis direction and the X axis direction by various kinds of feed mechanisms, guide mechanisms, servo motors, and the like provided in the saddle or the like.

Each of the tool spindle 221 and the tool post 231 may hold a rotary tool or a fixed tool. The rotary tool is such a tool that is rotated to machine a workpiece, such as a drill, an end mill, a reamer, or the like. The fixed tool is such a cutting tool that machines a rotating workpiece. When the rotary tool is held on the tool post 231, a motor that outputs rotation and a power transmission mechanism that transmits the rotation power output from the motor to the rotary tool are built into the tool post 231.

Each moving body of the work spindle 211, the opposing work spindle 216, the tool spindle 221, and the tool post 231 has a coordinate axis that serves as a reference in various operations such as movement, rotation, or turning. For example, the coordinate axes that may serve as a reference for the movement of the tool spindle 221 are the X axis, the Y axis and the Z axis, the coordinate axis that may serve as a reference for the movement of the opposing work spindle 216 is the Z axis, and the coordinate axes that may serve as a reference for the movement of the tool post 231 are the X axis and the Z axis. The central axis 301 is a coordinate axis that serves as a reference for the rotation of the work spindle 211, and is referred to as the “C axis” in the present specification. The central axis 304 is a coordinate axis that serves as a reference for the turning of the tool spindle 221, and is referred to as the “B axis” in the present specification.

The machine tool 200 further includes a cover body (a splash guard) 310. The cover body 310 forms an external appearance of the machine tool 200, and defines a machining area 300. The machining area 300 is a space in which a workpiece is machined, and is enclosed by the cover body 310 so as to prevent foreign matters such as chips or cutting oil related to the machining of the workpiece from leaking out of the machining area 300.

Although not illustrated in FIG. 2, an automatic tool changer (ATC) for automatically changing a tool held by the tool spindle 221 and a tool magazine for housing a replacement tool for the tool held by the tool spindle 221 are provided around the work spindle 211.

Next, the information processing apparatus 100 according to the present embodiment will be described. With reference to FIG. 1, each component of the information processing apparatus 100 is realized by hardware including an arithmetic unit such as a CPU (Central Processing Unit) and various computer processors, a storage device such as a memory or a storage, and a wired or wireless communication line connecting the arithmetic unit and the storage device, and software stored in the storage device and configured to supply a processing instruction to the arithmetic unit. A computer program may be a device driver, an operating system, various application programs located in an upper layer of the device driver and the operating system, or a library providing common functions to various application programs. Each block described below represents a functional unit block.

The information processing apparatus 100 includes a CL data acquisition unit 111 and a program generation unit 112.

The CL data acquisition unit 111 acquires CL data from an external source. The CL data acquisition unit 111 outputs the acquired CL data to a storage unit 136 to be described later. The program generation unit 112 generates an NC program from the CL data. The program generation unit 112 outputs the generated NC program to the storage unit 136.

The information processing apparatus 100 further includes a storage unit 136. The storage unit 136 stores various program modules. The processor of the information processing apparatus 100 implements the functions of each unit by executing various program modules.

The storage unit 136 further stores machine tool information 151, correspondence relationship information 152, acquired CL data 153, a selected machine tool 154, a selected controller 155, and a generated NC program 156.

The machine tool information 151 relates to machine specifications of a machine tool, and includes information on a machine origin, a machine stroke length, a machine axis configuration, and a numerical controller. The machine tool information 151 may further include information on a machine model number, option information (turret number, spindle diameter, servo, presence/absence and type of a chip conveyor, or presence/absence and type of a measuring device), usable tool types (e.g., drills, end mills), the number of pots and pot numbers of a tool magazine. The machine tool information 151 is created for each model of the machine tool.

In the present embodiment, machine tool information 151A, machine tool information 151B, machine tool information 151C, machine tool information 151D, and machine tool information 151E are stored in the storage unit 136 as the machine tool information 151. The machine tool information 151A, the machine tool information 151B, the machine tool information 151C, the machine tool information 151D, and the machine tool information 151E relate to the machine specifications for a machine tool of model A, a machine tool of model B, a machine tool of model C, a machine tool of model D, and a machine tool of model E, respectively.

The correspondence relationship information 152 relates to a correspondence relationship between CL data, controllers and NC codes. Since the NC code differs depending on the type of the controller (manufacturer) provided in the machine tool, in the correspondence relationship information 152, the correspondence relationship between the CL data and the NC codes is created for each type of the controller.

In the present embodiment, correspondence relationship information 152a, correspondence relationship information 152b, and correspondence relationship information 152c are stored in the storage unit 136 as the correspondence relationship information 152. The correspondence relationship information 152a relates to the correspondence relationship between the CL data and the NC codes for the controller of type Fa, the correspondence relationship information 152b relates to the correspondence relationship between the CL data and the NC codes for the controller of type Fb, and the correspondence relationship information 152c relates to the correspondence relationship between the CL data and the NC codes for the controller of type Fc.

The controller of type Fa, the controller of type Fb, and the controller of type Fc are manufactured by different controller manufacturers. For example, the controller of type Fa is manufactured by the FANUC Corporation, the controller of type Fb is manufactured by the Siemens Corporation, and the controller of type Fc is manufactured by the HEIDENHAIN Corporation.

The NC code may be different depending on the category to which the machine tool belongs (e.g. a lathe, a machining center, a composite machine). In this case, the correspondence relationship information 152 may relate to the correspondence relationship between the CL data, the controller, the category of the machine tool, and the NC code. In the correspondence relationship information 152, the correspondence relationship between the CL data and the NC code is created for each combination of the type of the controller and the category of the machine tool. Further, the NC code may be different depending on the version of a controller even if the controller is manufactured by the same manufacturer. In this case, in the correspondence relationship information 152, the correspondence relationship between the CL data and the NC code is created for each version of the controller.

The acquired CL data 153 corresponds to CL data input from the CL data acquisition unit 111. The selected machine tool 154 corresponds to a machine tool selected by the user from a model selection screen 142 to be described later. The selected controller 155 corresponds to a controller selected by the user from a model selection screen 142 to be described later. The generated NC program 156 corresponds to an NC program generated by the program generation unit 112.

The information processing apparatus 100 further includes a user interface processing unit 131. The user interface processing unit 131 processes information input by the user via a user interface such as a display, a keyboard, a mouse, a touch sensor, or a touch panel in which the display and the touch sensor are integrated.

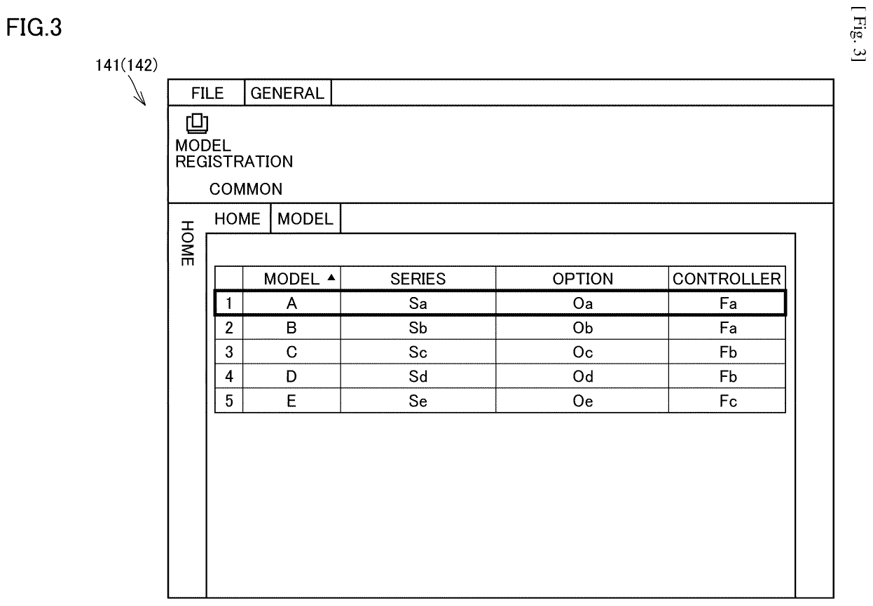

FIG. 3 is a diagram illustrating a model selection screen. With reference to FIGS. 1 and 3, the information processing apparatus 100 includes a GUI (Graphical User Interface) 141 as the user interface. The model selection screen 142 of the machine tool is displayed on the GUI 141.

The machine tools of models A to E are displayed on the model selection screen 142. The model selection screen 142 further displays series names Sa to Se for each model, optional models Oa to Oe for each machine tool model, and controllers of types Fa to Fe for each machine tool model. A controller of type Fa is provided for the machine tool of model A and the machine tool of model B, a controller of type Fb is provided for the machine tool of model C and the machine tool of model D, a controller of type Fc is provided for the machine tool of model E. The user selects a machine tool that uses the NC program generated by the information processing apparatus 100 from the machine tools of models A to E by using the model selection screen 142, and selects a controller for the selected machine tool.

When a machine tool and a controller are selected by the user via the GUI 141, the user interface processing unit 131 receives the selection. The user interface processing unit 131 outputs the selected machine tool 154 and the selected controller 155 to the storage unit 136.

The present embodiment is based on the assumption that a machine tool of model A and a controller of type Fa are selected from the model selection screen 142. The machine tool of model A corresponds to the machine tool 200 illustrated in FIG. 2.

With reference to FIG. 1, the user can further input various additional conditions for machining a workpiece via the GUI 141.

As an example, an additional condition for machining a workpiece may be a workpiece machining mode for optimizing machining accuracy and machining time.

The user can select a predetermined machining mode via the GUI 141 from four machining modes in the following: (a) time priority mode (a mode which prioritizes in shortening the machining time, and is used when the required accuracy is low such as rough machining), (b) intermediate mode (a mode which is located between time priority mode and accuracy priority mode, and is used in a semi-finishing machining when high accuracy and short time are required), (c) accuracy priority mode (a mode which prioritizes in machining accuracy, and is used when machining accuracy and finishing accuracy are required), and (d) higher accuracy priority mode (a mode which prioritizes in machining accuracy higher than that in the accuracy priority mode).

As another example, an additional condition may be the selection of a work spindle. The user can select one of the work spindle 211 and the opposing work spindle 216 in FIG. 2 as a work spindle for use in a predetermined machining step via the GUI 141.

The work spindle 211 may be set as a default work spindle, and the user may use the GUI 141 to set the opposing work spindle 216 as a default work spindle instead of the work spindle 211.

When an additional condition for machining a workpiece is input by the user via the GUI 141, the user interface processing unit 131 outputs the additional condition to the program generation unit 112.

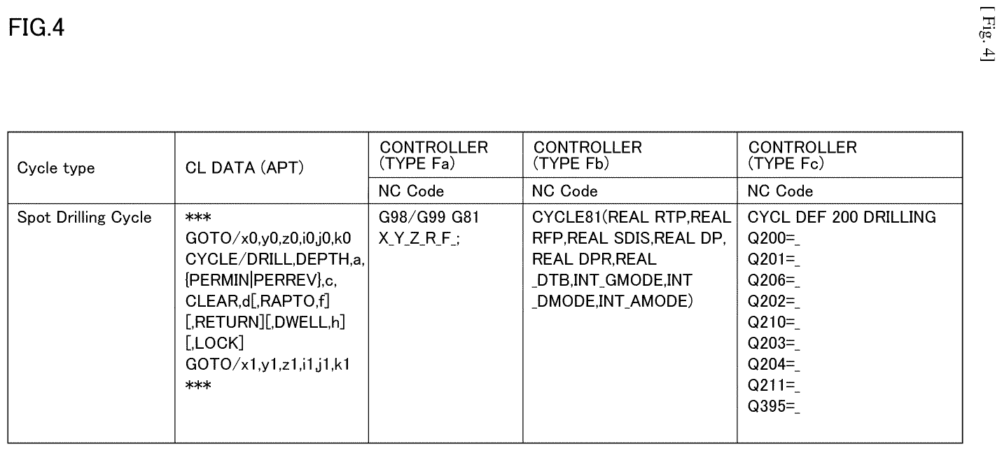

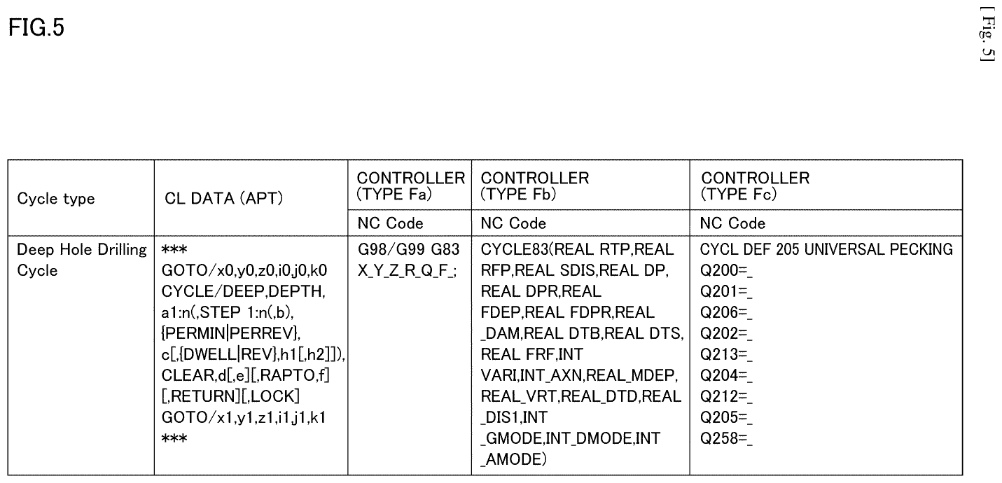

FIG. 4 is a table illustrating a correspondence relationship between CL data and NC codes used in various controllers in a drilling (spot drilling) cycle. FIG. 5 is a table illustrating a correspondence relationship between CL data and NC codes used in various controllers in a drilling (deep drilling) cycle.

With reference to FIGS. 1, 4 and 5, the program generation unit 112 generates an NC program from the acquired CL data 153 based on the selected controller 155 received by the user interface processing unit 131 and the correspondence relationship information 152 indicating a correspondence relationship between the selected controller 155, the CL data and an NC code.

More specifically, the program generation unit 112 includes a conversion unit 117. The conversion unit 117 retrieves the selected controller 155 from the storage unit 136. Based on the selected controller 155, the conversion unit 117 determines a controller of type Fa as the controller selected by the user. The conversion unit 117 specifies correspondence relationship information 152a indicating a correspondence relationship between the CL data and the NC code used in the controller of type Fa as the correspondence relationship information 152, and retrieves the correspondence relationship information from the storage unit 136. The conversion unit 117 retrieves the acquired CL data 153 from the storage unit 136. The conversion unit 117 converts the acquired CL data 153 into an NC program in accordance with the correspondence relationship (which is included in the correspondence relationship information 152a) between the CL data and the NC code used in the controller of type Fa.

As illustrated in FIGS. 4 and 5, the program generation unit 112 can generate an NC program for use in the controller of type Fa manufactured by the FANUC Corporation from the CL data described in APT.

When the user selects a machine tool of model C or model D and a controller of type Fb from the model selection screen 142 in FIG. 3, the conversion unit 117 converts the acquired CL data 153 into an NC program in accordance with the correspondence relationship (which is included in the correspondence relationship information 152b) between the CL data and the NC code used in the controller of type Fb. As illustrated in FIGS. 4 and 5, the program generation unit 112 can generate an NC program for use in the controller of type Fb manufactured by the Siemens Corporation from the CL data described in APT. When a machine tool of model E is selected and a controller of type Fc is selected by the user from the model selection screen 142 in FIG. 3, the conversion unit 117 converts the acquired CL data 153 into an NC program in accordance with the correspondence relationship (which is included in the correspondence relationship information 152c) between the CL data and the NC code used in the controller of type Fc. As illustrated in FIGS. 4 and 5, the program generation unit 112 can generate an NC program for use in the controller of type Fc manufactured by the HEIDENHAIN Corporation from the CL data described in APT.

The information processing apparatus 100 according to the present embodiment includes a user interface processing unit 131 that receives a selection of a controller for a machine tool, a storage unit 136 that stores a correspondence relationship between CL data, controllers and NC codes, and a program generation unit 112 that generates an NC program from the acquired CL data 153 based on (a) a selected controller 155 received by the user interface processing unit 131 and (b) a correspondence relationship between the selected controller 155, (b-1) the CL data and (b-2) the NC codes.

With this configuration, it is possible to generate an NC program suitable for the controller of the machine tool.

The model name of a machine tool may include a symbol indicating the type of a controller for use in the machine tool. For example, model Aa, model Ab and model Ac of the machine tool are displayed on the model selection screen 142, and the symbol “a” in the name of model Aa represents a controller manufactured by the FANUC Corporation, the symbol “b” in the name of model Ab represents a controller manufactured by the Siemens Corporation, and the symbol “c” in the name of model Ac represents a controller manufactured by the HEIDENHAIN Corporation. In this case, the type of a controller is not displayed on the model selection screen 142, and the user selects only the model of a machine tool.

When the model name of a machine tool includes a symbol indicating the type of a controller, the correspondence relationship information 152 in FIG. 1 relates to a correspondence relationship between the CL data, the machine tool and the NC code. In the correspondence relationship information 152 in FIG. 1, the correspondence relationship between the CL data and the NC code is created for each model of the machine tool.

The information processing apparatus according to the present modification includes a user interface processing unit 131 that receives a selection of a machine tool, a storage unit 136 that stores a correspondence relationship between CL data, machine tools and NC codes, and a program generation unit that generates an NC program from the CL data based on (a) a selected machine tool 154 received by the user interface processing unit 131 and (b) a correspondence relationship between the selected machine tool 154, (b-1) the CL data and (b-2) the NC codes.

In the present modification, when the model name of a machine tool includes a symbol indicating the type of a controller, it is also possible to generate an NC program suitable for the controller of the machine tool.

With reference to FIG. 1, the program generation unit 112 further generates an NC program from the CL data based on the machine tool information 151A.

More specifically, the conversion unit 117 retrieves the selected machine tool 154 from the storage unit 136. Based on the selected machine tool 154, the conversion unit 117 determines a machine tool of model A as the machine tool selected by the user. The conversion unit 117 specifies the machine tool information 151A indicating the machine specification for the machine tool of model A as the machine tool information 151, and retrieves the machine tool information from the storage unit 136.

The CL data includes information on the travelling path of a tool in each machining step, but may not include information on the travelling path of the tool during the transition from one machining step to another machining step, the travelling path of the tool during the ATC, or the like. On the other hand, depending on the mode of the machine tool, the axis configuration of a moving body such as the work spindle and the tool spindle, the position of the machine origin, the automatic tool replacement position by the ATC, the type of a usable tool, and the like may be different. The conversion unit 117 recognizes a specific machine specification for the machine tool of model A by referring to the machine tool information 151A, and generates an NC program corresponding to the specific machine specification.

When the CL data includes information on the travelling path of the tool during the transition from one machining step to another machining step and the travelling path of the tool during the ATC, the conversion unit 117 generates an NC program that reflects the information on the travelling path included in the CL data.

The program generation unit 112 further includes an additional condition reception unit 116. The additional condition reception unit 116 receives various additional conditions for machining a workpiece input from the user interface processing unit 131. The conversion unit 117 converts the CL data into an NC code that reflects the additional condition received by the additional condition reception unit 116.

For example, in the controller of type Fa, “G332” is an NC code to be inserted into the NC program when any of the machining modes (a) to (d) described above is selected. When the time priority mode (a) is selected by the user via the GUI 141, the conversion unit 117 inserts “G332R1” immediately before code G01 for starting the cutting operation. When the intermediate mode (b) is selected by the user via the GUI 141, the conversion unit 117 inserts “G332R2” immediately before code G01 for starting the cutting operation. When the accuracy priority mode (c) is selected by the user via the GUI 141, the conversion unit 117 inserts “G332R3” immediately before code G01 for starting the cutting operation. When the higher accuracy priority mode (d) is selected by the user via the GUI 141, the conversion unit 117 inserts “G332R4” immediately before code G01 for starting the cutting operation.

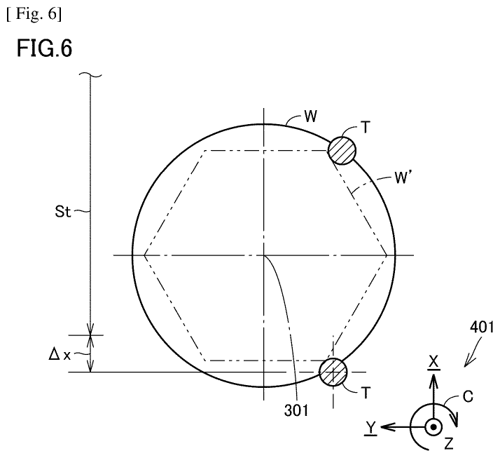

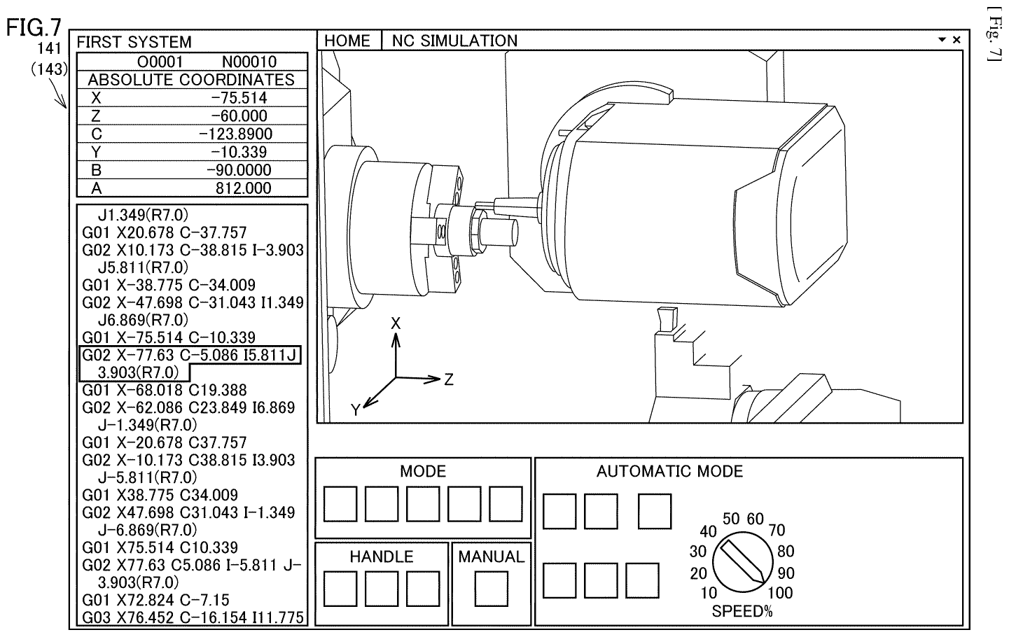

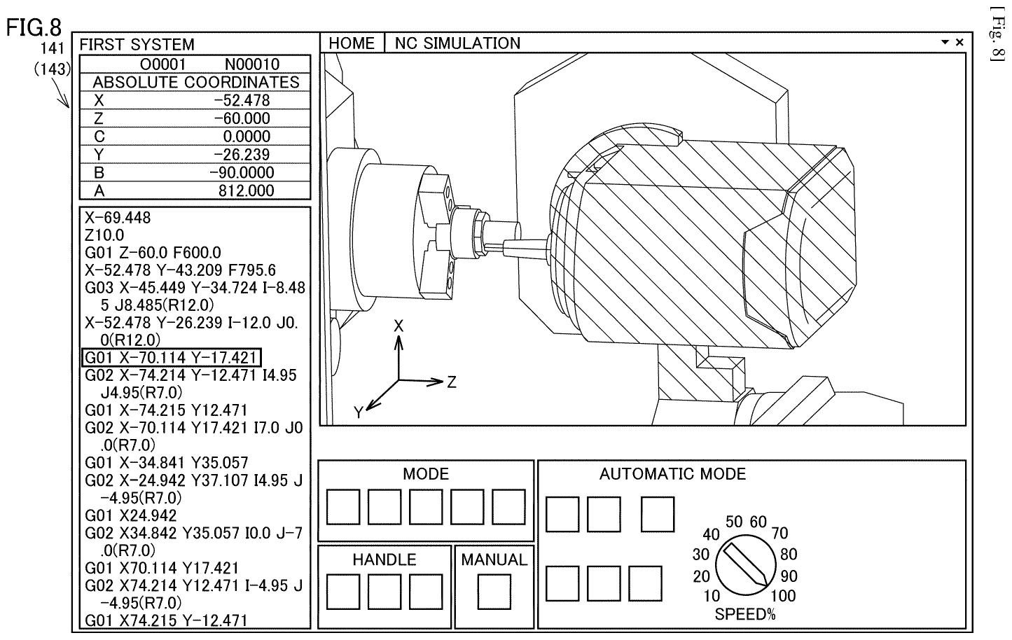

FIG. 6 is a diagram illustrating a step of machining a workpiece in a simulation of an NC program. FIGS. 7 and 8 are diagrams each illustrating a simulation screen of the NC program.

With reference to FIG. 1 and FIGS. 6 to 8, the information processing apparatus 100 further includes a simulation execution unit 113. The simulation execution unit 113 executes a simulation of the NC program generated by the program generation unit 112.

More specifically, the simulation execution unit 113 retrieves the generated NC program 156 from the storage unit 136. The simulation execution unit 113 executes a simulation of the generated NC program 156. As illustrated in FIGS. 7 and 8, a simulation screen 143 is displayed on the GUI 141. The simulation execution unit 113 displays the simulation of the generated NC program 156 on the simulation screen 143.

As illustrated in FIG. 6, the NC program simulated by the simulation execution unit 113 includes a machining step in which a tool T and a workpiece W are relatively moved with reference to a first coordinate system 401. The first coordinate system 401 is information that is included in the acquired CL data 153. The first coordinate system 401 is selected by the user when the CL data is created by the CAD/CAM device. Based on the acquired CL data 153, the program generation unit 112 generates an NC program that includes a machining step in which the tool T and the workpiece W are relatively moved with reference to the first coordinate system 401.

More specifically, a cylindrical workpiece W is held by the work spindle 211. In order to machine a workpiece W having a regular hexagonal outer shape from the cylindrical workpiece W, the work spindle 211 is fixed in the C-axis, and the tool T is brought into contact with the outer peripheral surface of the cylindrical workpiece W and moved in the X-Y plane. During this time, the cylindrical workpiece W and the tool T are relatively moved with reference to the first coordinate system 401 including the X axis and the Y axis.

The simulation execution unit 113 determines whether or not an error is present in the simulation of the NC program.

The error refers to various events that may interfere with the progress of the workpiece machining, such as an interference, an overtravel, an axis configuration mismatch, or the like of a moving body, which will be described later. The moving body refers to an object that moves in a machining area along with the workpiece machining, and may be, for example, a tool spindle, a work spindle, a tool post, a table, or the like.

The simulation execution unit 113 includes an interference determination unit 121, an overtravel determination unit 122, and an axis configuration determination unit 124.

The interference determination unit 121 determines whether or not an interference is present in the moving body according to the simulation of the NC program. When it is determined that an interference is present in the moving body, the interference determination unit 121 sends an alert to notify the user of an interference in the moving body.

When the tool spindle 221 that holds the tool T is moved in the −X axis direction in the machining step illustrated in FIGS. 6 to 8, the interference determination unit 121 determines that an interference is present between the tool spindle 221 and the tool holder held by the tool post 231. As illustrated in FIG. 8, the interference determination unit 121 sends an alert to the user by displaying the tool spindle 221 and the tool post 231 in a specific color such as red.

In the simulation of the NC program, the overtravel determination unit 122 determines whether or not an overtravel that the moving body moves beyond a movable region is present. When it is determined that an overtravel of the moving body is present, the overtravel determination unit 122 sends an alert to the user that notifies the user of an overtravel of the moving body.

In the machining steps illustrated in FIGS. 6 to 8, when the tool spindle 221 that holds the tool T moves in the −X axis direction, the overtravel determination unit 122 determines that an overtravel that the tool spindle 221 moves beyond the movable region St in the X axis direction by Ax is present. The interference determination unit 121 sends an alert to the user by displaying the tool spindle 221 in a specific color such as red.

In the simulation of the NC program, the axis configuration determination unit 124 determines whether or not a coordinate axis that does not constitute an axis configuration in which the moving body is movable is included in the first coordinate system 401. When it is determined that a coordinate axis that does not constitute an axis configuration in which the moving body is movable is included in the first coordinate system 401, the axis configuration determination unit 124 sends an alert to the user that notifies the user of an axis configuration mismatch of the moving body.

For example, the machine tool 200 in FIG. 2 includes a tool post 231 movable in the Z axis direction and the X axis direction as a moving body. The axis configuration determination unit 124 determines that an axis configuration mismatch is present when the first coordinate system 401 that serves as a reference coordinate system in the machining step by using the tool held by the tool rest 231 includes a Y axis that does not constitute the axis configuration in which the tool rest 231 is movable. The interference determination unit 121 sends an alert to the user by displaying the tool post 231 in a specific color such as red.

The alert for notifying the user is not particularly limited, and may be, for example, a text displayed on the simulation screen 143 for notifying the user of an interference of the tool spindle 221, an overtravel of the tool spindle 221, or an axis configuration mismatch of the moving body such as the tool post 231.

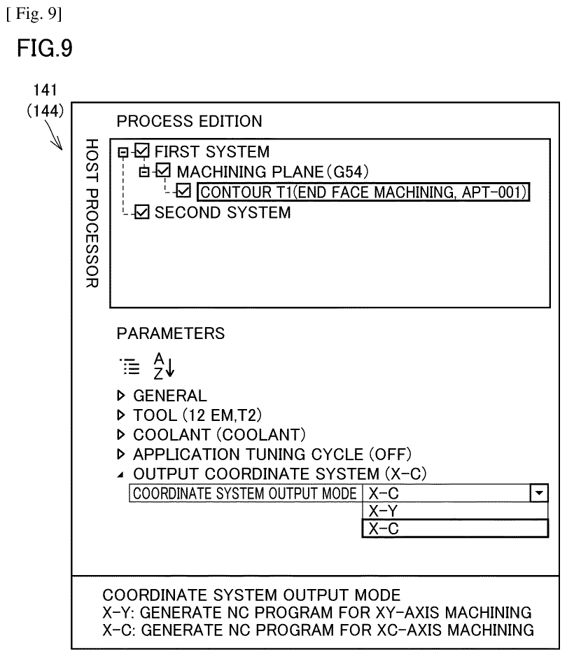

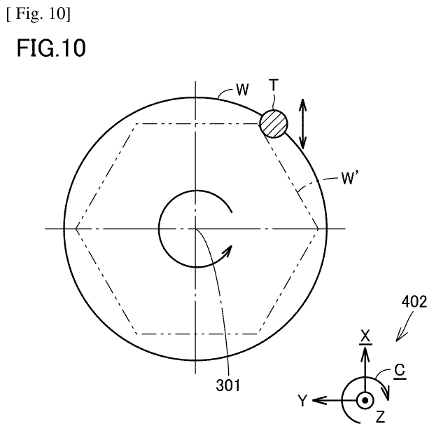

FIG. 9 is a diagram illustrating a coordinate system selection screen. FIG. 10 is a diagram illustrating a step of machining a workpiece in a re-simulation of an NC program.

With reference to FIG. 1, FIG. 9 and FIG. 10, if the simulation of the NC program reveals that an error is present in the machining step in which the tool T and the workpiece W are relatively moved with reference to the first coordinate system 401, the simulation execution unit 113 presents to the user a second coordinate system 402 which is a combination of coordinate axes constituting the coordinate system and is different from the first coordinate system 401 as an alternative to the first coordinate system 401.

More specifically, when the interference determination unit 121 determines that an interference of the tool spindle 221 is present, when the overtravel determination unit 122 determines that an overtravel of the tool spindle 221 is present, and/or when the axis configuration determination unit 124 determines that an axis configuration mismatch of the moving body is present, the simulation execution unit 113 causes the GUI 141 to display the coordinate system selection screen 144.

The simulation execution unit 113 further includes an alternative coordinate system presentation unit 123. The alternative coordinate system presentation unit 123 retrieves the machine tool information 151A from the storage unit 136. The alternative coordinate system presentation unit 123 refers to the machine tool information 151A to specify the second coordinate system 402 as a candidate coordinate system to replace the first coordinate system 401 in the machining step illustrated in FIG. 6, and displays the second coordinate system 402 on the coordinate system selection screen 144. The user can select the second coordinate system 402 from the coordinate system selection screen 144.

The first coordinate system 401 is a combination of coordinate axes of the X axis and the Y axis, and the second coordinate system 402 is a combination of coordinate axes of the C axis and the X axis. The combination of coordinate axes constituting the first coordinate system 401 and the combination of coordinate axes constituting the second coordinate system 402 are different from each other.

The number of the candidate coordinate systems replacing the first coordinate system 401 is not limited to one, and may be more than one. The number of coordinate axes constituting the coordinate system is not limited to two, and may be three or more.

When the second coordinate system 402 is selected by the user via the GUI 141, the simulation execution unit 113 outputs the second coordinate system 402 to the program generation unit 112 as an additional condition for machining a workpiece. The additional condition reception unit 116 receives the additional condition input from the simulation execution unit 113.

The program generation unit 112 re-generates an NC program from the acquired CL data 153. During this time, the conversion unit 117 converts the acquired CL data 153 into an NC program in which the additional condition received by the additional condition reception unit 116 is reflected. The program generation unit 112 generates an NC program in which the first coordinate system 401, which is used as a reference coordinate system in the machining step where an error is found, is replaced by the second coordinate system 402.

The simulation execution unit 113 executes a re-simulation of the NC program generated by the program generation unit 112. The simulation execution unit 113 determines whether or not the error has been solved in the re-simulation of the NC program. The simulation execution unit 113 outputs the NC program to the machine tool 200 when the error has been solved in the re-simulation.

As illustrated in FIG. 10, in the re-simulation of the NC program, when the second coordinate system 402 which is a combination of the C-axis and the X axis is applied, the tool T is moved in the X axis direction (the upward-downward direction) while being kept in contact with the outer peripheral surface of the workpiece W, and the workpiece W is rotated about the C-axis (the central axis 301). In this case, the tool spindle 221 is reciprocated in the +X axis direction (the upward direction) and the −X axis direction (the downward direction) to form one side of the regular hexagon on the outer peripheral surface of the workpiece W, and the reciprocating movement of the tool spindle 221 is repeated in the X axis direction to form the outer peripheral surface of the workpiece W into a regular hexagonal shape. Since the moving width of the tool spindle 221 in the X axis direction is in a limited range, the interference and the overtravel of the tool spindle 221 can be avoided.

In addition, since the first coordinate system 401 that serves as a reference coordinate system in the machining step by using the tool held by the tool rest 231 includes the Y axis which does not constitute the axis configuration in which the tool rest 231 is movable, when the axis configuration determination unit 124 determines that there is an axis configuration mismatch, the alternative coordinate system presentation unit 123 may present the second coordinate system 402 including the C axis, the X axis and/or the Z axis to the user instead of the Y axis.

The information processing apparatus 100 according to the present embodiment includes a program generation unit 112 that generates an NC program from CL data, and a simulation execution unit 113 that executes a simulation of the NC program. When the first coordinate system 401 is selected, the program generation unit 112 generates an NC program that results in a machining step including relative movements with reference to the first coordinate system 401, and when the second coordinate system 402 is selected, the program generation unit generates an NC program that results in a machining step including relative movements with reference to the second coordinate system 402.

According to this configuration, when the first coordinate system 401 is selected, an NC program that results in a machining step including relative movements with reference to the first coordinate system 401 is generated, and when the second coordinate system 402 is selected, an NC program that results in a machining step including relative movements with reference to the second coordinate system 402 is generated, and thereby the NC program can be generated according to the simulation result.

In addition, when the simulation of the NC program reveals that an error is present in the machining step in which the tool and the workpiece are relatively moved with reference to the first coordinate system 401, the second coordinate system 402 is presented to the user to replace the first coordinate system 401. Thus, the user can attempt to solve the error found in the machining step simply by selecting the second coordinate system 402.

The machine tool includes a moving body that holds one of a tool and a workpiece and moves in a machining area. The error may be an interference of the moving body in the machining area, an overtravel that the moving body moves beyond a movable region, or an axis configuration mismatch in which a coordinate axis that does not constitute an axis configuration in which the moving body is movable is included in the first coordinate system.

The axis configuration determination unit 124 in FIG. 1 may be incorporated into the program generation unit 112 instead of the simulation execution unit 113.

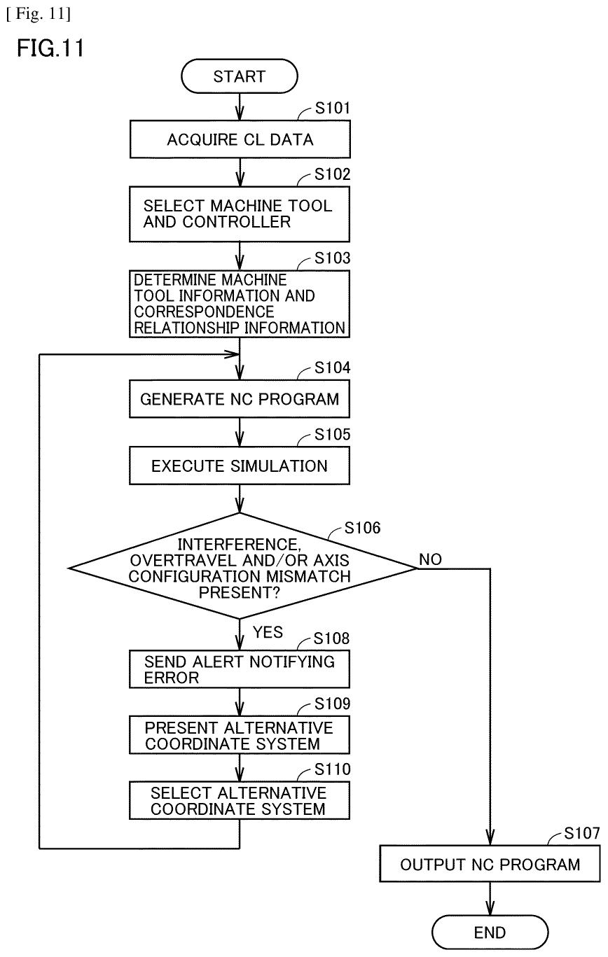

FIG. 11 is a flowchart illustrating a process of generating an NC program in the information processing apparatus illustrated in FIG. 1.

With reference to FIGS. 1 and 11, the CL data acquisition unit 111 acquires CL data created by the CAD/CAM device (S101). In this step, the CL data acquisition unit 111 outputs the acquired CL data to the storage unit 136 as the acquired CL data 153.

The information processing apparatus 100 receives a machine tool and a controller in which an NC program to be generated is used (S102). In this step, the user causes the GUI 141 to display the model selection screen 142 in FIG. 3, and selects a machine tool and a controller from the model selection screen 142. The user interface processing unit 131 receives the selection of the machine tool and the controller, and outputs them to the storage unit 136 as the selected machine tool 154 and the selected controller 155, respectively.

Next, the program generation unit 112 determines the machine tool information 151 and the correspondence relationship information 152 (S103).

In this step, the program generation unit 112 retrieves the selected machine tool 154 and the selected controller 155 from the storage unit 136. The program generation unit 112 determines the machine tool information 151A indicating a machine specification of the machine tool of model A as the machine tool information 151 based on the selected machine tool 154, and retrieves the machine tool information from the storage unit 136. Based on the selected controller 155, the program generation unit 112 determines, as the correspondence relationship information 152, a correspondence relationship information 152a indicating a correspondence relationship between the CL data and the NC code for use in the controller of type Fa, and retrieves the correspondence relationship information from the storage unit 136.

Next, the NC program generation unit 112 generates an NC program (S104). In this step, the NC program generation unit 112 retrieves the acquired CL data 153 from the storage unit 136. The NC program generation unit 112 generates an NC program from the CL data based on the machine tool information 151A and the correspondence relationship information 152a. When an additional condition for machining a workpiece is input via the GUI 141, the NC program generation unit 112 generates an NC program that reflects the additional condition. The NC program generation unit 112 outputs the generated NC program to the storage unit 136 as the generated NC program 156.

Next, the simulation execution unit 113 executes a simulation of the NC program (S105).

In this step, the user causes the GUI 141 to display the simulation screen 143 in FIG. 3, and starts an operation of executing a simulation on the simulation screen 143. The simulation execution unit 113 executes a simulation of the generated NC program 156 and displays the simulation on the simulation screen 143.

Next, the simulation execution unit 113 determines whether or not an interference, an overtravel, and/or an axis configuration mismatch is present in the moving body (S106). In this step, the interference determination unit 121 determines whether or not an interference is present in the moving body, the overtravel determination unit 122 determines whether or not an overtravel is present in the moving body, and the axis configuration determination unit 124 determines whether or not an axis configuration mismatch is present in the moving body.

Next, when it is determined in step S106 that an interference, an overtravel /d/ or an axis configuration mismatch is not present in the moving body, the simulation execution unit 113 outputs the NC program to the machine tool.

When it is determined in step S106 that an interference, an overtravel, and/or an axis configuration mismatch is present in the moving body, the simulation execution unit 113 sends an alert to the user that notifies the user of the error (S108). The simulation execution unit 113 presents an alternative coordinate system to the user (S109). In this step, the alternative coordinate system presentation unit 123 displays the alternative coordinate system on the coordinate system selection screen 144. The user selects the alternative coordinate system displayed on the coordinate system selection screen 144.

Next, the program generation unit 112 receives the alternative coordinate system selected by the user as the additional condition (S110).

Next, the process returns to the step of S104 where the program generation unit 112 regenerates an NC program (S104). At this time, the program generation unit 112 generates an NC program that reflects the alternative coordinate system selected by the user. Next, in the step of S105, the simulation execution unit 113 re-simulates the NC program, and outputs the NC program to the machine tool when it is determined in the step of S106 that an interference, an overtravel, and an axis configuration mismatch is not present in the moving body.

If it is determined in the step of S106 that an interference, an overtravel, and an axis configuration mismatch is present the moving body, the steps of S108, S109 and S110 may be executed again. In this case, in step S109, an alternative coordinate system that will replace the second coordinate system may be presented to the user.

The method for generating an NC program according to the present embodiment includes a step (S102) of receiving a selection of a controller for a machine tool; and a step (S104) of generating an NC program from the acquired CL data 153 based on (a) a selected controller 155 received in the step (S102) of receiving a selection of a controller for the machine tool and (b) a correspondence relationship between the selected controller 155, (b-1) the CL data and (b-2) the NC codes.

Further, the control program according to the present embodiment causes the information processing apparatus 100 to execute: a step (S102) of receiving a signal specifying a selection of a controller for the machine tool; and a step (S104) of generating an NC program from the acquired CL data 153 based on (a) a selected controller 155 received in the step (S102) of receiving a signal specifying a selection of a controller for the machine tool and (b) a correspondence relationship between the selected controller 155, (b-1) the CL data and (b-2) the NC codes. When the selection of a controller for the machine tool is received by a device different from the information processing apparatus 100, the control program may cause the information processing apparatus to execute a step of receiving a signal specifying the selection of a controller from the different device.

The program according to the present embodiment is a program for generating an NC program for use in a machine tool. The program causes a computer to execute: a step (S102) of receiving a signal specifying a selection of a controller for the machine tool; and a step (S104) of generating an NC program from the CL data based on (a) a selected controller 155 received in the step (S102) of receiving a signal specifying a selection of a controller for the machine tool and (b) a correspondence relationship between the selected controller 155, (b-1) the CL data and (b-2) the NC codes.

A computer-readable storage medium according to the present embodiment is configured to store a program for generating an NC program for use in a machine tool, and the program causes a computer to execute: a step (S102) of receiving a signal specifying a selection of a controller for the machine tool; and a step (S104) of generating an NC program from the CL data based on (a) a selected controller 155 received in the step (S102) of receiving a signal specifying a selection of a controller for the machine tool and (b) a correspondence relationship between the selected controller 155, (b-1) the CL data and (b-2) the NC codes. The computer readable storage medium may be a non-transitory computer readable storage medium.

Even when the model of the machine tool includes a symbol indicating the type of the controller, the generation method of the NC program, the control program, the program, and the computer-readable storage medium can be constructed in the same manner as described above.

According to the aforementioned configuration, it is possible to generate an NC program suitable for the controller of the machine tool.

The method for generating an NC program according to the present embodiment includes a step (S105) of executing a simulation of an NC program that results in a machining step including relative movements with reference to the first coordinate system 401, and a step (S104) of generating an NC program that results in a machining step including relative movements with reference to the second coordinate system 402 when the second coordinate system 402 is selected after the step (S105) of executing the simulation.

In addition, the control program according to the present embodiment causes at least one information processing apparatus 100 to execute a step (S105) of executing a simulation of an NC program that results in a machining step including relative movements with reference to the first coordinate system 401, and a step (S104) of generating an NC program that results in a machining step including relative movements with reference to the second coordinate system 402 when the second coordinate system 402 is selected after the step (S105) of executing the simulation. The information processing apparatus controlled by the control program to execute the step of executing the simulation of the NC program and the information processing apparatus controlled by the control program to execute the step of generating the NC program may be different from each other.

More specifically, the method for generating an NC program according to the present embodiment includes a step (S104) of generating an NC program that results in a machining step including relative movements with reference to the first coordinate system 401 from the CL data including the selection of the first coordinate system 401, a step (S105) of executing a simulation of the NC program, and a step (S104) of generating an NC program that results in a machining step including relative movements with reference to the second coordinate system 402 when the second coordinate system 402 is selected after the step (S105) of executing the simulation of the NC program.

Further, the control program according to the present embodiment causes at least one information processing apparatus 100 to execute a step (S104) of generating an NC program that results in a machining step including relative movements with reference to the first coordinate system 401 from the CL data including the selection of the first coordinate system 401, a step (S105) of executing a simulation of the NC program, and a step (S104) of generating an NC program that results in a machining step including relative movements with reference to the second coordinate system 402 when the second coordinate system 402 is selected after the step (S105) of executing the simulation of the NC program.

According to such a configuration, it is possible to generate an NC program according to the result of the simulation.

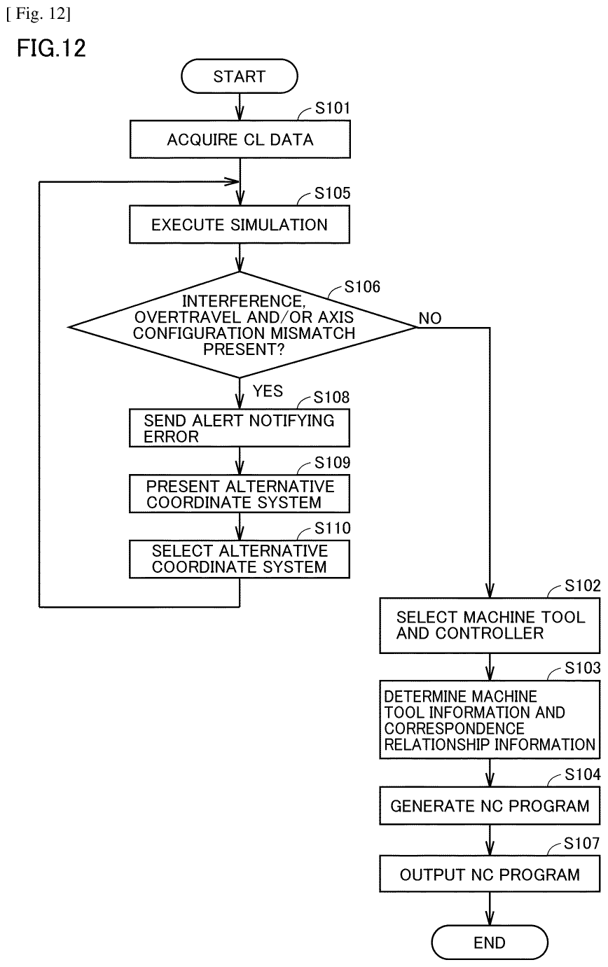

FIG. 12 is a flowchart illustrating a process of generating an NC program in a modification of the information processing apparatus illustrated in FIG. 1. The steps in the flowchart of FIG. 12 corresponding to the steps in the flowchart of FIG. 11 are denoted by the same reference numerals.

As described in the present modification with reference to FIG. 12, the simulation execution unit 113 in FIG. 1 may execute a simulation of CL data.

First, the CL data acquisition unit 111 acquires the CL data created by the /D/ CAM device (S101).

Next, the simulation execution unit 113 executes a simulation of the CL data (S105). In this step, the simulation execution unit 113 retrieves the acquired CL data 153 from the storage unit 136. The simulation execution unit 113 executes a simulation of the acquired CL data 153 and displays the simulation on the simulation screen 143.

Next, the simulation execution unit 113 determines whether or not an interference, an overtravel, and/or an axis configuration mismatch is present in the moving body (S106).

When it is determined in step S106 that an interference, an overtravel and/or an axis configuration mismatch is not present in the moving body, the process proceeds to steps S102 to S104 so as to generate an NC program from the CL data. The steps of S102 and S103 may be executed before the simulation of the CL data. In step S104, the program generation unit 112 generates an NC program that results in a machining step including relative movements with reference to the first coordinate system 401. After the step of S104, the program generation unit 112 outputs the NC program to the machine tool.

When it is determined in step S106 that an interference, an overtravel and/or an axis configuration mismatch is present in the moving body, the simulation execution unit 113 sends an alert to the user that notifies the user of the error (S108). The simulation execution unit 113 presents an alternative coordinate system to the user (S109). The user selects the second coordinate system 402 displayed on the coordinate system selection screen 144 as the alternative coordinate system. The information processing apparatus 100 receives the alternative coordinate system selected by the user (S110). The information processing apparatus 100 rewrites the CL data so as to reflect the alternative coordinate system selected by the user, and outputs the rewritten CL data to the simulation execution unit 113.

Next, the process returns to the step of S105 where the simulation execution unit 113 executes the re-simulation of the CL data, and proceeds to the step of S102 when it is determined in the step of S106 that an interference, an overtravel, and an axis configuration mismatch is not present in the moving body. In step S104, the program generation unit 112 generates an NC program that results in a machining step including relative movements with reference to the second coordinate system 402.

The information processing apparatus according to the present modification includes a program generation unit 112 that generates an NC program from the CL data, and a simulation execution unit 113 that executes a simulation of the CL data. When the first coordinate system 401 is selected, the program generation unit 112 generates an NC program that results in a machining step including relative movements with reference to the first coordinate system 401, and when the second coordinate system 402 is selected, generates an NC program that results in a machining step including relative movements with reference to the second coordinate system 402.

In addition, the method for generating an NC program according to the present modification includes a step (S105) of executing a simulation of the CL data that results in a machining step including relative movements with reference to the first coordinate system 401, and a step (S104) of generating an NC program that results in a machining step including relative movements with reference to the second coordinate system 402 when the second coordinate system 402 is selected after the step (S105) of executing the simulation.

Further, the control program according to the present modification causes at least one information processing apparatus to execute a step (S105) of executing a simulation of the CL data that results in a machining step including relative movements with reference to the first coordinate system 401, and a step (S104) of generating an NC program that results in a machining step including relative movements with reference to the second coordinate system 402 when the second coordinate system 402 is selected after the step (S105) of executing the simulation.

It should be understood that the embodiments disclosed herein are illustrative and non-restrictive in all respects. The scope of the present invention is defined by the terms of the claims rather than the description of the embodiments above, and is intended to include any modifications within the scope and meaning equivalent to the terms of the claims.

This non-provisional application is based on Japanese Patent Application No. 2023-209792 filed on Dec. 13, 2023 and Japanese Patent Application No. 2024-065534 filed on Apr. 15, 2024 with the Japan Patent Office, the entire contents of which are hereby incorporated by reference.

### REFERENCE SIGNS LIST

100: information processing apparatus; 111: data acquisition unit; 112: program generation unit; 113: simulation execution unit; 116: additional condition reception unit; 117: conversion unit; 121: interference determination unit; 122: overtravel determination unit; 123: alternative coordinate system presentation unit; 124: axis configuration determination unit; 131: user interface processing unit; 136: storage unit; 142: model selection screen; 143: simulation screen; 144: coordinate system selection screen; 151, 151A, 151B, 151C, 151D, 151E: machine tool information; 152, 152a, 152b, 152c: correspondence relationship information; 200: machine tool; 211: work spindle; 213: first chuck mechanism; 216: opposing work spindle; 218: second chuck mechanism; 221: tool spindle; 223: spindle end surface; 231: tool post; 232: turning portion; 236: bed; 300: machining area; 206, 301, 302, 303, 304: central axis; 310: cover body; 401: first coordinate system; 402: second coordinate system.

1. An information processing apparatus that generates an NC program for use in a machine tool, the information processing apparatus comprising:
a user interface processing unit that receives a selection of a controller for the machine tool;
a storage unit that stores a correspondence relationship between CL data, controllers and NC codes; and
a program generation unit that generates an NC program from the CL data based on (a) a selected controller received by the user interface processing unit and (b) a correspondence relationship between the selected controller, (b-1) the CL data and (b-2) the NC codes.

2. An information processing apparatus that generates an NC program for use in a machine tool, the information processing apparatus comprising:
a user interface processing unit that receives a selection of the machine tool;
a storage unit that stores a correspondence relationship between CL data, machine tools and NC codes; and
a program generation unit that generates an NC program from the CL data based on (a) a selected machine tool received by the user interface processing unit and (b) a correspondence relationship between the selected machine tool, (b-1) the CL data and (b-2) the NC codes.

3. A method for generating an NC program for use in a machine tool, the method comprising:
a step of receiving a selection of a controller for the machine tool; and
a step of generating an NC program from the CL data based on (a) a selected controller received in the step of receiving a selection of a controller for the machine tool and (b) a correspondence relationship between the selected controller, (b-1) the CL data and (b-2) the NC codes.

4. A method for generating an NC program for use in a machine tool, the method comprising:
a step of receiving a selection of the machine tool; and
a step of generating an NC program from the CL data based on (a) a selected machine tool received in the step of receiving a selection of the machine tool and (b) a correspondence relationship between the selected machine tool, (b-1) the CL data and (b-2) the NC codes.

5. A program for generating an NC program for use in a machine tool, the program causing a computer to execute:
a step of receiving a signal specifying a selection of a controller for the machine tool; and
a step of generating an NC program from the CL data based on (a) a selected controller received in the step of receiving a signal specifying a selection of a controller for the machine tool and (b) a correspondence relationship between the selected controller, (b-1) the CL data and (b-2) the NC codes.

6. A program for generating an NC program for use in a machine tool, the program causing a computer to execute:
a step of receiving a signal specifying a selection of the machine tool; and
a step of generating an NC program from the CL data based on (a) a selected machine tool received in the step of receiving a signal specifying a selection of the machine tool and (b) a correspondence relationship between the selected machine tool, (b-1) the CL data and (b-2) the NC codes.
